(19) United States
(12) Patent Application Publication
(10) Pub. No.: US 2011/0320221 A1
(43) Pub. Date: Dec. 29, 2011

(54) METHOD AND SYSTEM FOR COMMUNICATING PATIENT INFORMATION

(76) Inventors: Barbara Duffey-Rosenstein, Toronto (CA); Anita Low, Richmond Hill (CA); Giancarlo De Lio, Toronto (CA); Silvia Dos Santos, Toronto (CA); Quin Powell, Toronto (CA); Amanda Grant, Toronto (CA); Jody Tone, Toronto (CA); Syed Ain, Oakville (CA); Nicolas Hariton, Burnaby (CA); Kenneth Locke, Mississauga (CA)

(21) Appl. No.: 13/230,139

(22) Filed: Sep. 12, 2011

Related U.S. Application Data
(62) Division of application No. 11/951,773, filed on Dec. 6, 2007, now abandoned.

(51) Int. Cl. G06Q 50/00

(52) U.S. Cl. 705/3

(57) ABSTRACT

A method of communicating a patient care message is disclosed. The method comprises inputting patient information into the patient care message; inputting an urgency indicator into the patient care message; inputting health condition information into the patient care message; transmitting the patient care message electronically, wherein the patient care message comprises the patient information, the urgency indicator, and the health condition information.

### CROSS-REFERENCE TO RELATED APPLICATIONS

This application is a divisional of patent application Ser. No. 11/951,773, filed on Dec. 6, 2007, which is incorporated herein by reference in its entirety.

### FIELD

The embodiments described herein relate to method and systems for communication within health care facilities, and more specifically to methods and systems for prioritizing patient related messages within health care facilities.

### BACKGROUND

It is estimated that some physicians when on-call receive over a hundred pages per shift. As the physicians must respond to each of these pages, they are often required to interrupt or delay urgent or important tasks to respond to these pages. As the paging information simply provides a call back number, the physician generally has no way of knowing the importance of the page. Therefore, they must call the paging individual back immediately to determine the nature of the page. As a result, the physician does not make an efficient use of their time when forced to respond to pages that involve situations that may be handled at a later time.

### SUMMARY

In one aspect of the invention a method of communicating a patient care message is disclosed. The method comprises inputting patient information into the patient care message; inputting an urgency indicator into the patient care message; inputting health condition information into the patient care message; transmitting the patient care message electronically, wherein the patient care message comprises the patient information, the urgency indicator, and the health condition information.

In another aspect of the invention a method of creating a task for completion by a health care professional where the task is associated with a patient is disclosed. The method comprises inputting patient information associated with the task; inputting a time duration for completion of the task; adding the task to an electronic task list associated with the patient; and monitoring the task list for non completed tasks, and electronically notifying the health care professional about non completed tasks.

In another aspect of the invention a method of recording patient care tasks for completion by a health care professional. The method comprises inputting patient information associated with the patient care task;

inputting whether the patient care task is an urgent task inputting health condition information associated with the patient care task; adding the patient care task to a patient task list; and accessing the patient task list to mark a patient care task as completed or not completed.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment and in which:

FIG. 1 is a block diagram of a prior art paging system used by health care facilities;

FIG. 2 is a flowchart illustrating the steps of a prior art paging method;

FIG. 3 is a block diagram of a health care facility communication system according to an embodiment of the present invention;

FIG. 4 is a block diagram of the components of a communication application according to an embodiment of the present invention;

FIG. 5 is a flowchart illustrating the steps of a patient message communication method;

FIG. 6 is a flowchart illustrating the steps of a physician workflow method;

FIG. 7 is a sample screen shot of a login window;

FIG. 8 is a sample screen shot of a patient list window;

FIG. 9 is a sample screen shot of a patient edit window;

FIG. 10 is a sample screen shot of a departmental list window;

FIG. 11 is a sample screen shot of a urgent task window; and

FIG. 12 is a sample screen shot of a non-urgent task window.

It will be appreciated that, for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example, and without limitation, the programmable computers may be a mainframe computer, server, personal computer, laptop, personal data assistant, or cellular telephone. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer-usable instructions may also be in various forms, including compiled and non-compiled code.

The embodiments of the invention described herein relate generally to a health care facility communication system that prioritizes and communicates patient care messages from health care professionals to other health care professionals. The method and system described herein relate generally to health care facilities, where both health care professionals and patients are found. The health care facilities may include, but are not limited to hospitals, veterans' wards, long-term care facilities, and rehabilitation facilities. For purposes of example, the embodiments described herein are described with reference to a hospital. Health care professionals may include, but are not limited to physicians, nurses, occupational therapists, physiotherapists, respiratory therapists, students, physicians in training, pharmacists and any other group involved in delivering care to patients. For purposes of example, the embodiments described herein are described in relation to the communication of patient health messages to physicians. The term patient health message is used herein to refer to any message regarding a patient that is communicated among the respective professionals involved in delivering care to a patient.

In hospital-based settings, it is necessary for various health care professionals to work together to ensure the delivery of health care to patients. Various health care professionals work with physicians to deliver health care to patients. Often, nurses and other such professionals assess a patient and communicate with a physician regarding the condition and/or needs of the patient. In the embodiments described herein, if it is determined that a physician's intervention or help is required, the nurse will contact the physician through use of the communication system described below and provide electronic prioritized messages. The prioritized messages are transmitted through a central server that allows for them and their completion status including the time of the message and similar components to be kept track of. The prioritized messages that are delivered to the physician allow the physician to undertake their tasks with greater efficiency as there is less reason to disrupt often critical tasks to respond to a message regarding a task that may be completed much later.

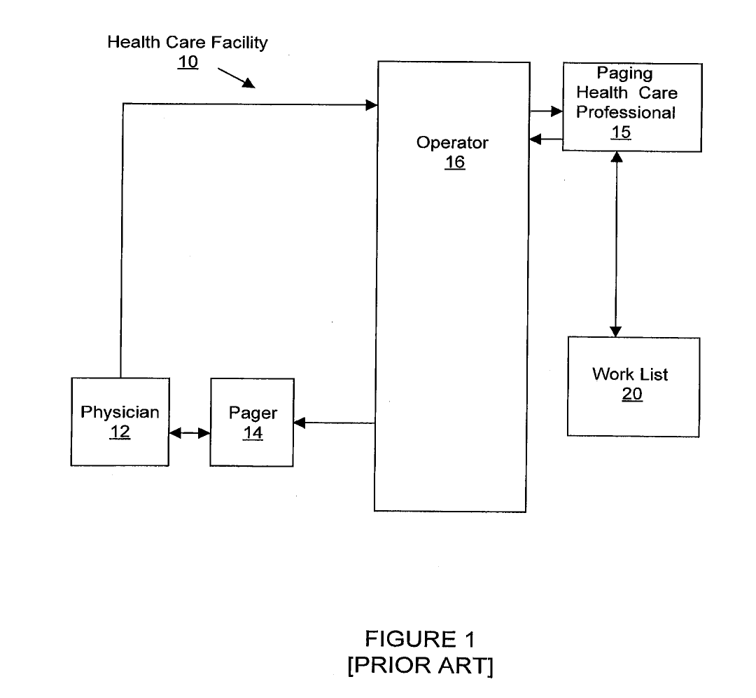

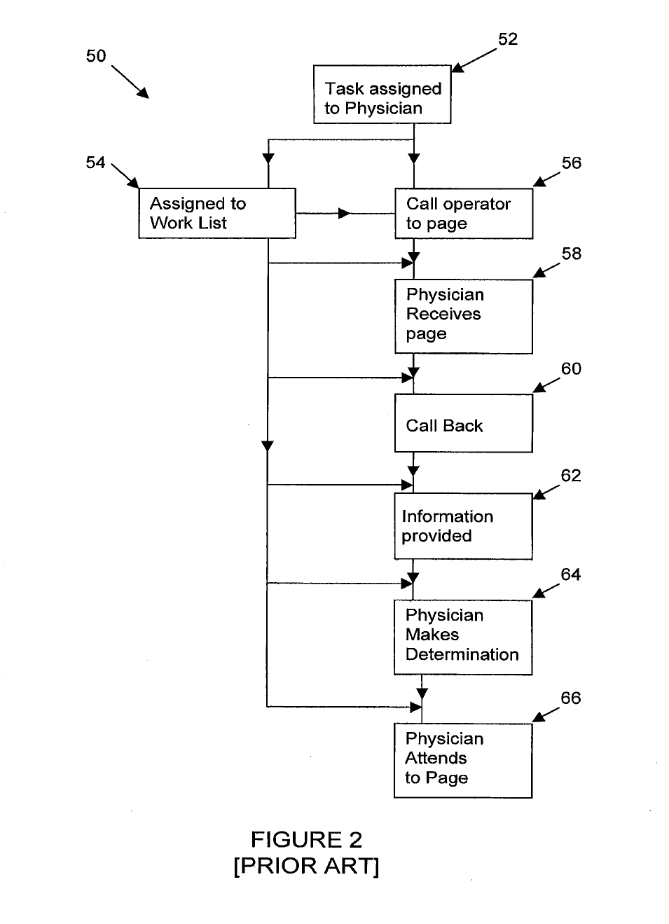

Reference is now made to FIGS. 1 and 2, where the prior art systems and methods used in and by health care facilities for the communication of patient care messages to physicians are shown. Generally, in conventional communication mechanisms, as illustrated with reference to the figures below, physicians receive patient care messages through either calling another staff member in response to a page that is received or by being required to consult a list where messages regarding specific patients are posted.

With reference to FIG. 1, a block diagram illustrating the path of message communicated in a health care facility 10 is shown. Health care professionals 15 who require that patient information be provided to the physicians, either page the physician 12 or proceed to place the information on a work list 20. Located throughout the hospital, on the various units, are found what are referred to as scut-lists, which are hereinafter referred to as work-lists. Work-lists are paper lists that are found on the various respective wards that include patient care messages or action items that are addressed to physicians 12. For example, the patient care messages may relate to an update regarding a patient's condition, and to a request for a task to be carried out by a physician 12 with regards to one or more of the patients on the ward or in the respective department. Often, tasks that are placed on the work lists are not time sensitive tasks that require the physician's immediate attention, and are often tasks that can wait for the physician 12 to have time to be completed. The physicians within a hospital are expected and required to consult the respective work lists for which they are responsible throughout the course of their shift. Therefore, when a physician 12 finds himself/herself engaged with urgent tasks, the tasks that are entered onto the respective wor-lists may not receive immediate attention.

Where the health care professional 15 does not wish to place the tasks on the work list 20 (such as when the message is of increased urgency), the health care professional 15 proceeds to page the physician 12. When paging the physician, the health care professional first must contact an operator 16. The operator 16 proceeds to ask the calling professional 15 for information regarding whom they want to page. The operator 16 is generally an internal hospital operator, however the operator may be also located external to the hospital facility. The operator 16 then proceeds to send a page to the physician's pager 14. Messages that are sent to the physician 12 provide a call back number to the physician 12. The physician must then call the number that was sent to the pager 14, and speak to the health care professional 15 requesting the page, in order to receive the message regarding the patient. The physician 12 in addition to needing to respond to the page almost immediately in order to receive patient care messages, must also visit the respective wards to determine the tasks that must be completed with regards to the various work lists that are there for them to monitor and complete. Therefore, the physician 12 when receiving a message is not made aware as to any context regarding the nature of the message, including whether it requires the physician's immediate attention, or whether the physician 12 may wait to complete any task associated with the message.

Reference is now made to FIG. 2, where a prior art flowchart diagram illustrating the steps of a physician task list method 50 is shown. The physician task list method 50 illustrates the communication methods in relation to the receipt of patient care messages by physicians. Referring to FIGS. 1 and 2, method 50 begins at step 52, where a determination is made by a health care professional 15 that a patient message must be communicated to the physician 12. As described above, the health care professional initially makes a determination as to whether the message must be communicated to the physician through the paging system or through the use of a work list. Where the health care professional has made a determination that the task/job or message should be communicated to the health care professional through the work list, the task is added to the work list at step 54. It is shown at step 54 that the tasks assigned to work lists 20 may also be communicated to the respective physician 12 through use of a paging system. For example, if the tasks on the work lists have not been completed and are growing, the health care professional may proceed to page the physician 12 regarding these tasks. At step 56, the health care professional 15 proceeds to call the operator to page the physician 20. The health care professional 15 provides a call back number where the health care professional 15 can be reached. Method 50 proceeds to step 58 where the physician receives the page. Once the physician 12 receives the page, the physician 12 calls back at step 60. The physician 12 however may receive the page while he/she is performing other tasks. Therefore, physicians 12 are not able to always call back right away to retrieve the message and to speak to the health care professional 15 who has originated the page. Also, because physicians 12 receive pages where they must respond to them immediately in cases of emergency and other non-emergency though urgent tasks, physicians 12 will often interrupt their current tasks to respond to pages. However, as the physician has no way of discriminating between pages that relate to urgent matters and those that relate to non-urgent matters, the interruption of a physician's activity to respond to what are non-urgent pages is inefficient. Method 50 then proceeds to step 62, where physician receives the information from the health care professional 15. At step 64, the physician 12 makes a determination with regards to categorizing the message as one that requires urgent attention, or one that can wait to be handled at a later time. At step 66, based on the determination and prioritization the physician 12 has made in relation to the task, the physician at an appropriate time attends to the task.

As can be seen by the description of method 50, the physician must make time for completing tasks that are included on the work list. The physician 12 is generally expected to visit the wards and or/areas where the respective work lists are posted at frequent intervals. The physician may be in the middle of performing jobs that are indicated on the work lists when the physician receives a page, thereby further delaying the completion of jobs on the work list. As can be seen by the description that is provided in relation to FIGS. 1 and 2, the physician 12 is not provided with an appropriate method by which to help triage (categorize) the messages that are received without having to speak to a respective health care professional.

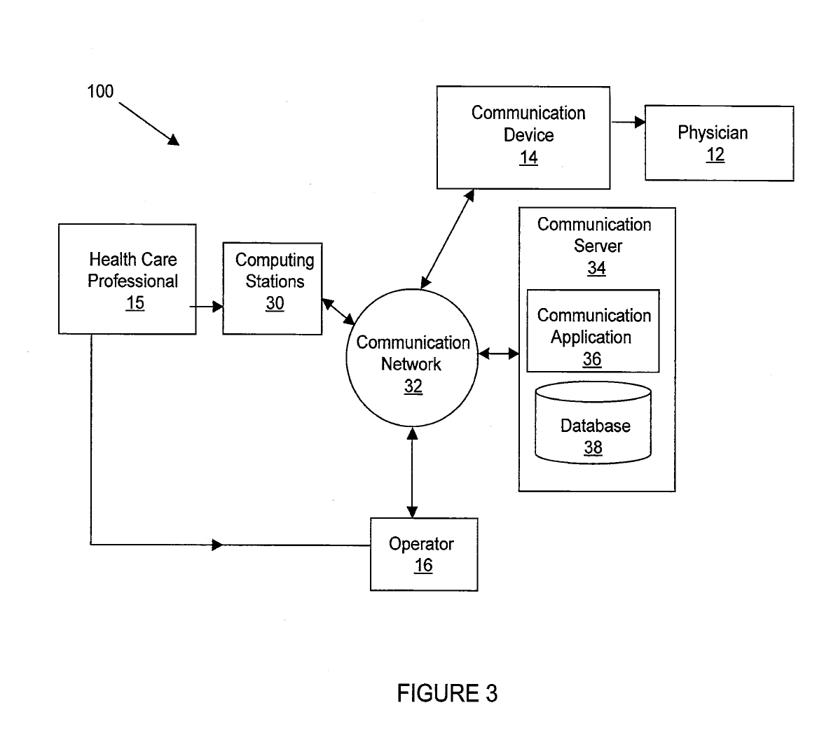

Reference is now made to FIG. 3, where a block diagram illustrating the components of a hospital based messaging system 100 is shown in an exemplary embodiment of the present invention. The hospital based messaging system 100 is used to implement embodiments of the systems and methods that are described herein. The system 100 allows for patient care messages to be transmitted to the physician 12 in an electronic format that allows the physician to determine the urgency of the message, without being required to call a health care professional 15.

The system 100 in an exemplary embodiment comprises a computing station 30 accessed by a health care professional 15 in order to communicate patient care messages to the physician. The health care professional 15 in an exemplary embodiment communicates a patient based message through the use of a computing station 30. The computing station 30 is accessible to a communication network 32. Upon the health care professional 15 interacting with the computing station 30, the computing station 32 then communicates with the communication server 34. The communication server 34 is a server-type computing device that communicates with the communication network 32. Preferably, the communication server 34 has accessible to it or resident upon it, a communication application 36. The communication application 36 is preferably a software application that receives, records and transmits messages to the respective communication devices 14. The communication server 34 also has accessible to it a data storage repository, such as a database 38 that stores both physician and patient related records that are described in further detail below.

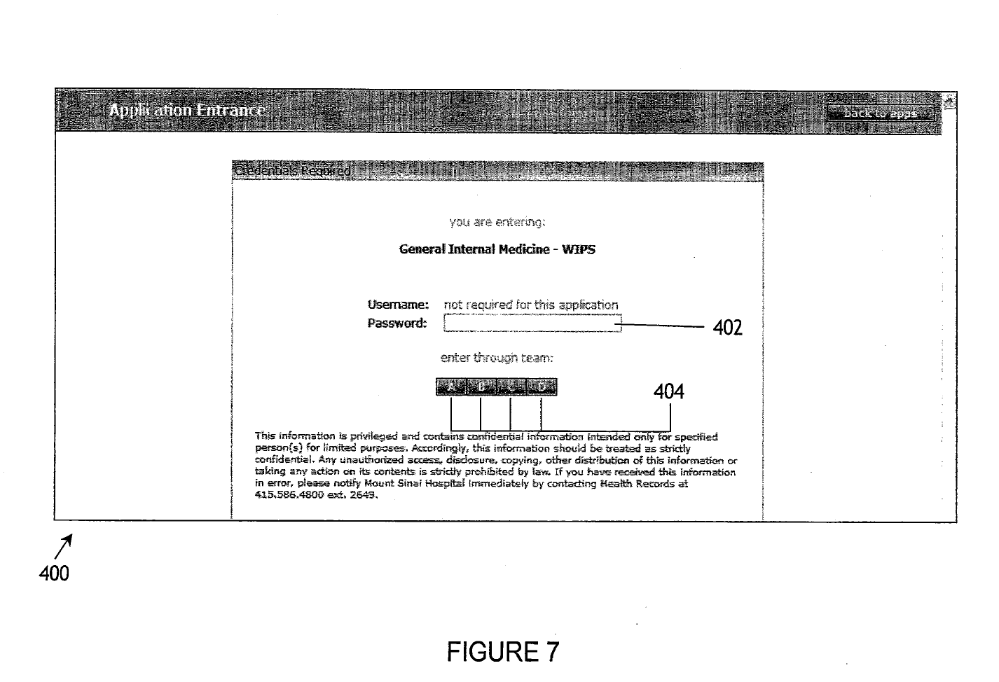

The computing station 30 may be any type of computing device that allows for a connection with a communication network 32, has a display and a mechanism by which information may be input. The computing station 30, may be, but is not limited to a workstation computer, a server type computer, a laptop computer, or a handheld computer. For clarity, only one computing station 30 is illustrated in FIG. 7. However, it will be understood by those skilled in the art that any suitable number of computing stations 30 may be available to health care professionals 15.

The communication network 32 is any network that allows for communication between computing devices. The communication network may be a local area network (LAN), wide area network (WAN), fiber network, Ethernet, the Intranet or the Internet. As the system 100 herein is being described with respect to deployment within one hospital facility, the communication network 32 for purposes of example will be the Intranet of a hospital. Where the system 100 is deployed across more than one facility, the Internet may be used for purposes of the communication network 32.

The communication server 34 communicates via the communication network 32 to receive messages from the computing station 30. The communication server 34 then transmits the appropriate electronic messages to the respective communication device 14. The communication server 34 that can host the communication application 36 and that allows for connectivity to a communication network 32. The communication server 36 may also have access to or be considered to be an email server which causes the respective patient care messages to be transmitted to the appropriate communication devices. The communication device 14 may be any portable device that is able to receive messages, and may include, but is not limited to pagers, mobile phones and handheld computers. The messages may be transmitted as pages, SMS messages, or electronic-mail messages. For clarity, only one communication device is illustrated in FIG. 3. However, those skilled in the art will understand that any suitable number of communication devices 14 may be available to health care professionals 15.

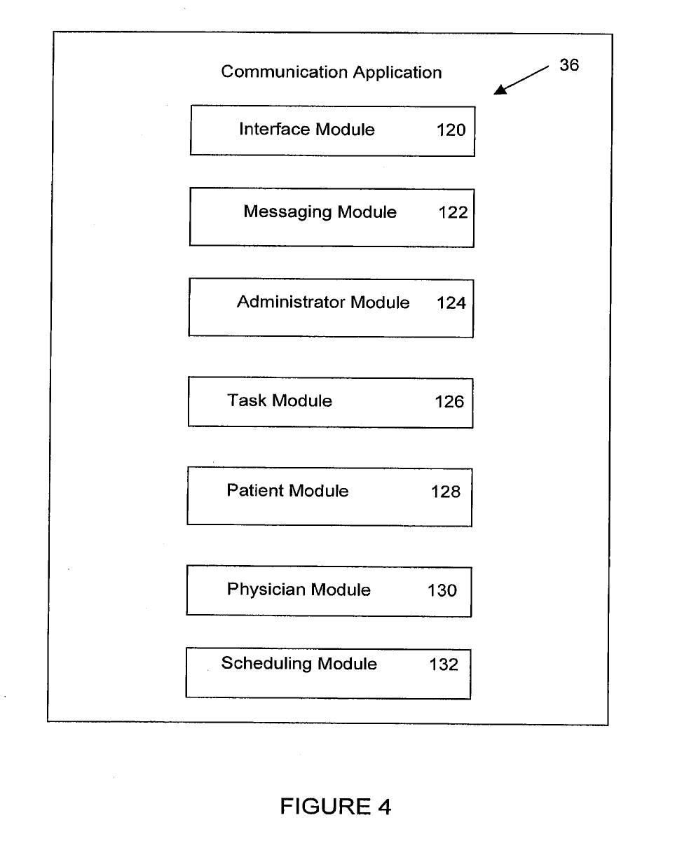

The communication application 36 is a software application that is used to receive, process and transmit messages. The communication application 36 is described in further detail with respect to FIG. 4. The physicians 12 and other health care professionals 15 may access the communication application 36 through either departmental or individual access to the system 100. Each user may login to the system 100 and access the application 36 in order to transmit and receive messages, and update/edit information in respect of messages, as is explained below.

The communication database 38 stores information regarding the respective patients associated with the facility, and regarding users of the system 100.

Reference is now made to FIG. 4, wherein a block diagram illustrating the components of the communication application is shown in an exemplary embodiment. The communication application 36 has associated with it various modules that provide the functionality that is described herein. The respective modules that are described herein are described for purposes of illustration of one embodiment, wherein additional modules may be included, and the modules may be combined with regards to their functionality into one or more modules. In one embodiment, the communication application has associated with it an interface module 120, a messaging module 122, an administrator module 124, a task module 126, a patient module 128, a physician module 130, and a scheduling module 132.

The interface module 120 provides the respective users with access to the system 100, and provides access to the respective functionality that is illustrated herein. The respective interfaces are illustrated in further detail with reference to the various screen shots that are shown below.

The messaging module 122 provides users with the ability to send messages to physicians 12. As is explained in further detail below, physicians receive messages through the communication server 32 through more than one method. One such method of receiving messages involves the posting of tasks/jobs upon a website where the physician may then check and monitor their respective tasks online. Another method involves the use of the communication application to generate and send a message to the physician's communication device 14. The messages content of the message provide specific details to the receiving physician regarding the patient where the messages are urgent messages. In an exemplary embodiment, the urgent message includes information regarding the patient, health professional and the health professional's contacts.

The administrator module 124 provides an administrator of the system 100 with access to allow for administrative tasks to be completed.

The task module 126 keeps track of the respective tasks. The task module 126 stores information regarding each task that is assigned to a physician, related to a patient, requested by a health professional and associated with a respective department or ward. The task module 126 determines which non-urgent tasks remain to be completed and sends reminders to physicians regarding which tasks have to be completed. The task module 126 also determines which tasks have been completed and proceeds to send notifications to the appropriate requesting health care professional. The requesting health care professional 15 may receive notifications regarding task completion through a message to a communication device 14, if they have one, or through a message that is viewed when the next access to the system 100 is made through the computing device 30. The task module 126 also keeps records of all of the respective messages and users of the system 100. Reports may be generated based on various criteria, including tasks by patient, by physician, by requesting professional, time taken for completion, types of tasks completed and tasks by department.

The patient module 128 is used to manage information regarding the various patients that are residents of, or associated with the hospital facility 10. The patient module 128 allows information to be entered and edited regarding patients. When a patient message is entered into the system, the patient module 128 allows for a message that is transmitted to the respective communication device 14 to include information regarding the patient.

The physician module 130 is used to manage information regarding the various physicians that are part of the hospital facility 10. The physician module 130 includes information regarding the physician, their schedule, and their contact information. The use of the physician module 130 is illustrated in further detail below.

The scheduling module 132 tracks the time that is allotted by the health care provider for the respective tasks to be completed. Where the tasks have not been completed within certain allotted time, or where reminders of work-list tasks are required to be sent, the scheduling module 132 generated the appropriate reminders and notifications.

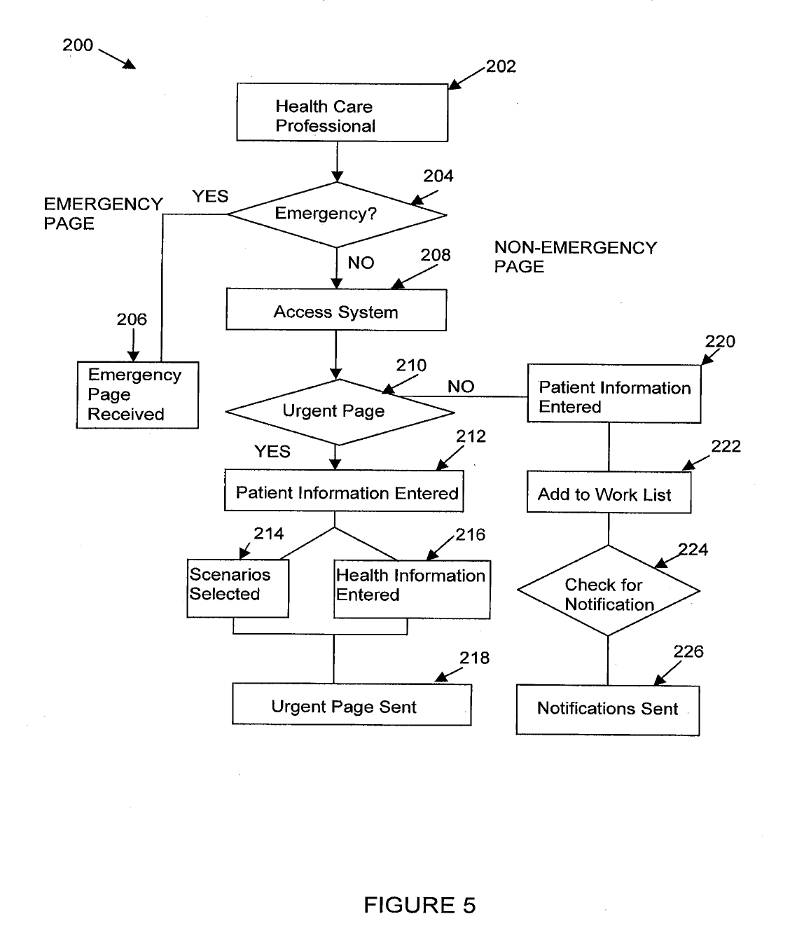

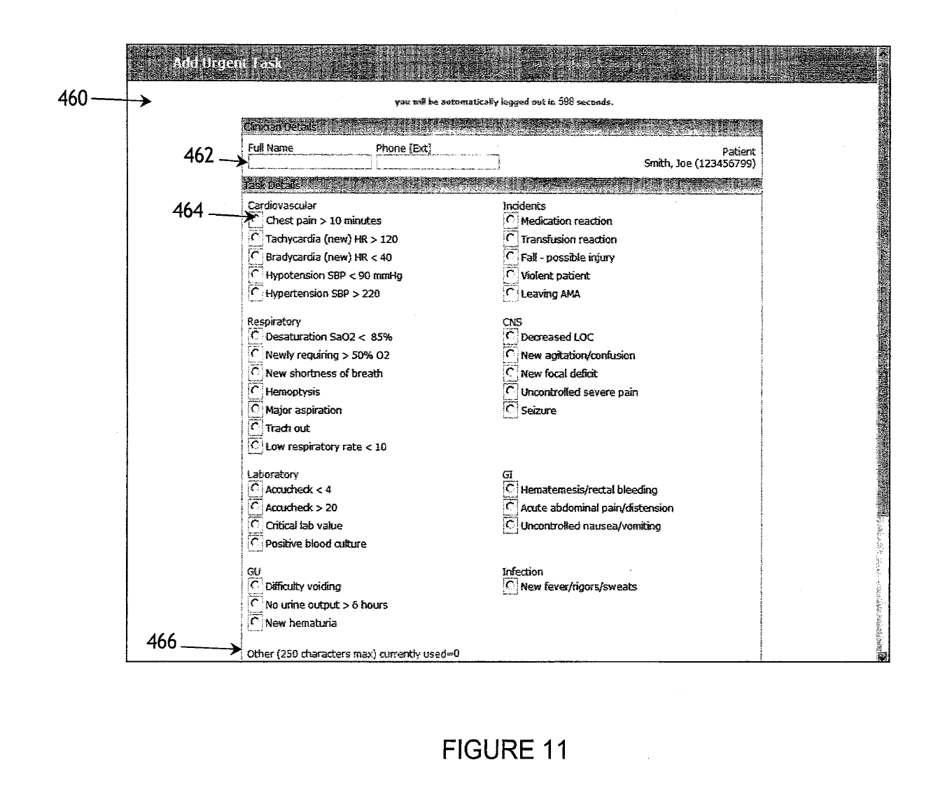

Reference is now made to FIG. 5, where a flowchart illustrating the steps of a patient message communication method 200 is shown in an exemplary embodiment. The patient message communication method incorporates the use of the system 100 and provides physicians with patient care messages that are classified as requiring urgent attention or not. Method 200 begins at step 202, where the health care professional 15 becomes aware of a situation that requires the attention of the physician 12. The health care professional when presented with an emergency situation will contact the physician with an emergency page or message at step 206. If the situation is non-urgent and does not require the attention of a physician immediately, then the health professional makes use of the system 100 to communicate the message to the physician 12 through accessing the communication application 36 at step 208. Users of the system 100, in an exemplary embodiment are required to login to the system 100. After logging into the system, the health care professional must determine whether the task requires urgent attention at step 210. Where the health care professional has determined that the matter is an urgent matter method 200 proceeds to step 212. At step 212, the patient information is entered. As described with reference to FIGS. 7 to 12, the patient information may be selected from a list of patients that are accessible through the system, or the patient information may be entered into the system 100. The communication application 36 has access in an exemplary embodiment to a directory or database that stores patient information regarding patients that are part of the respective hospital facility. Therefore, a list of patients that are in the health care facility may be selected and an individual patient may be selected from the list of patients that are displayed. Upon selecting, or where selection is not possible, entering patient information, method 200 proceeds to step 214 or 216. At step 214 or step 216, the health care professional must provide information regarding the health care condition and/or health care requirements associated with the patient. The health care professional may select from more than one method to provide the contextual health information. The system 100 will allow the health care professional to select predefined health care scenarios, as illustrated for purposes of example in FIG. 11, that may be added to and edited by an appropriate user. The predefined health care scenarios are specific in one embodiment to the department to which the patient has been admitted. For example, where the patient is a patient in the general medicine ward, the lists of scenarios displayed to the user, are generally reflective of issues that are found in general medicine. At step 214, the health care professional selects from the specified health care scenarios, and at step 216 the user enters the respective health care scenarios if an appropriate one is not found.

At step 218, the message is transmitted to the physician. The physician, upon receiving the urgent care message, will receive information regarding the patient, and also receive information regarding the medical context as specified by the health care professional. Therefore, the need to then call the operator and/or respective department back to determine whether a message is urgent is eliminated and the physician does not need to interrupt his/her current activity to determine if a message that is received is an urgent message, as all messages received in relation to a patient by the physician are urgent.

If it is determined at step 210 that the situation is non-urgent, method 200 proceeds to step 220. At step 220, the patient information is entered by the health professional. The patient information may be entered through accessing the database of patients in the system 100, or through directly entering the patient information into the system 100. Method 200 then proceeds to step 222, where the work list is updated. The task or job that the health professional requires to be undertaken by the physician 12 is included on the work list. Preferably, tasks that are included on the respective work lists are not automatically communicated to the respective physicians. The physicians are expected to check the work-lists at frequent intervals. As the work lists are accessible through the communication application 36, the physicians 12 are able to access them at any time. Method 200 then proceeds to step 224, where a check is performed to determine whether notifications regarding the tasks that are part of the work lists are sent to the physician 12. Notifications may be sent at predetermined time intervals, or at predetermined times of the day. Further, notifications may be sent when the state of the work list is monitored. The work list monitoring may take into account a variety of factors, including the number of tasks that require completion, and the timing conditions associated with each of these conditions.

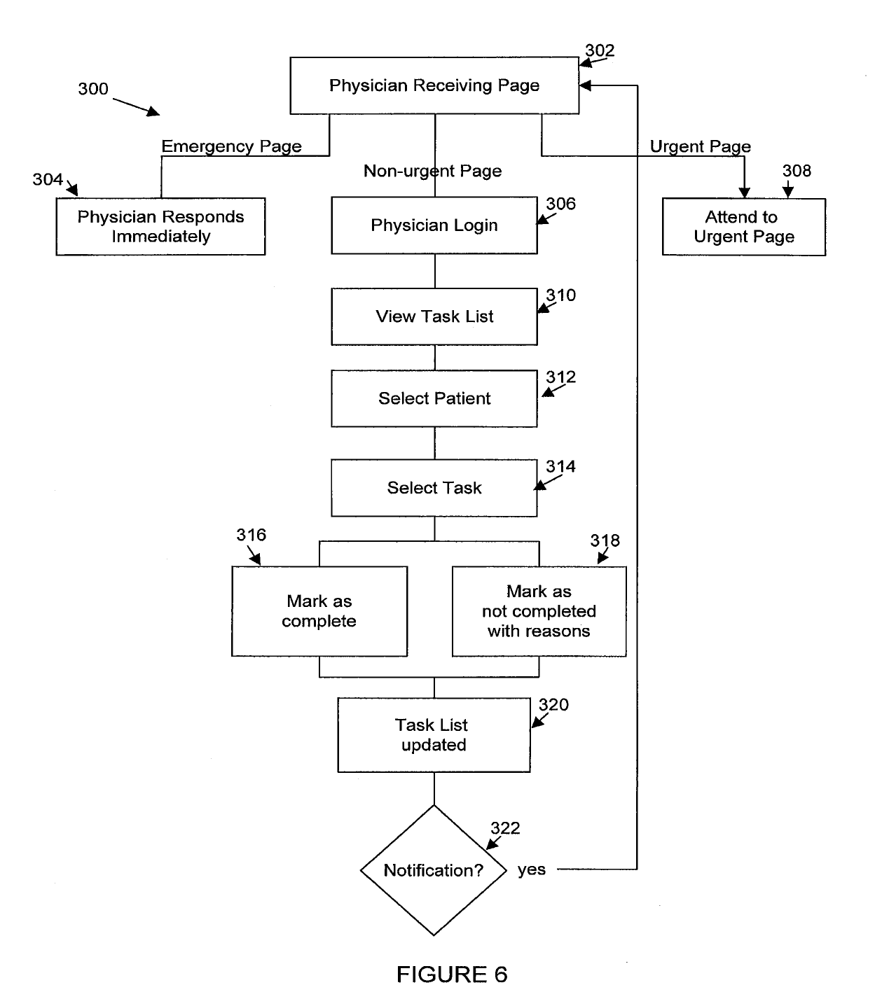

Reference is now made to FIG. 6, where a flowchart illustrating the steps of a physician workflow method 300 is shown according to an exemplary embodiment. The physician workflow method 300 describes the steps that are undertaken by a physician who uses the system 100 to respond to patient care messages. Method 300 illustrates the steps that a physician may take in response to having received a patient message. Method 300 begins at step 302, where the physician receives a patient message. The patient message indicates whether the message is an emergency message that must be responded to immediately. Where the message must be responded to immediately, method 300 proceeds to step 304, where the physician takes the necessary steps to respond. If it is determined that the message notification that is received at step 302 is an urgent message, method 300 proceeds to step 308, where the physician attends to or prioritizes the urgent message.

If the communication that is received at step 302 is a non-urgent message, method 300 proceeds to step 306. At step 306, the physician accesses the system by providing a user ID and password. The physician 12 accesses the system 100 to review the work-lists at a time when the physician is available to do so. Method 300 then proceeds to step 310 where the physician views a general task list indicating the tasks that are to be completed. By selecting a patient at step 312, the physician 12 at step 314 is able view tasks that are specific to the patient. When the physician first accesses the system 10, the physician in an exemplary embodiment is shown their entire patient list. For each patient information will be displayed indicating any urgent or non urgent tasks associated with the patient and any overdue or outstanding non urgent tasks. Upon viewing the respective tasks, the physician 12 may mark the task as having been completed at step 316, or that it remains to be completed at step 318. Where the tasks remain to be completed, and the physician 12 wishes to provide reasons as to why the tasks have not been completed, the physician 12 is able to enter comments regarding the tasks. The comments that are provided are part of the task list and are viewable to other users of the system 100. Therefore, when a requesting health professional wishes to check on the status of the task list, when viewing the task list they will be able to see that the physician is aware of the tasks through the reasons they have provided for it not being completed. At step 320, the task list is updated and the records are stored in the database or memory store. Method 300 then proceeds to step 322 where a determination is made whether notifications should be sent. Notifications are sent to both the physician and the health care professional in various instances. The health care professionals who have requested the task may receive notifications where the tasks that they have submitted have been completed when they login to the system 10. Reference is now made to FIGS. 7 to 12, where sample screen shots for an exemplary embodiment of the present invention are shown. The sample screen shots have been shown for purposes of example, to illustrate the functionality that is provided by the system 100 and the respective interfaces. Reference is now made to FIG. 7, where a sample sign in screen 400 is shown. The sample sign in screen is used to log in and access the system 100. Each user of the system 100, including health care professionals and physicians 12 have access to the system 100 have access to a user ID and password if necessary that is used to access the system 100. The user enters his user ID and password in a login window 402. Where the user is a member of a team or department and wishes to see tasks that are specific to the user's department, the user may select the appropriate department through engaging the department icon 404.

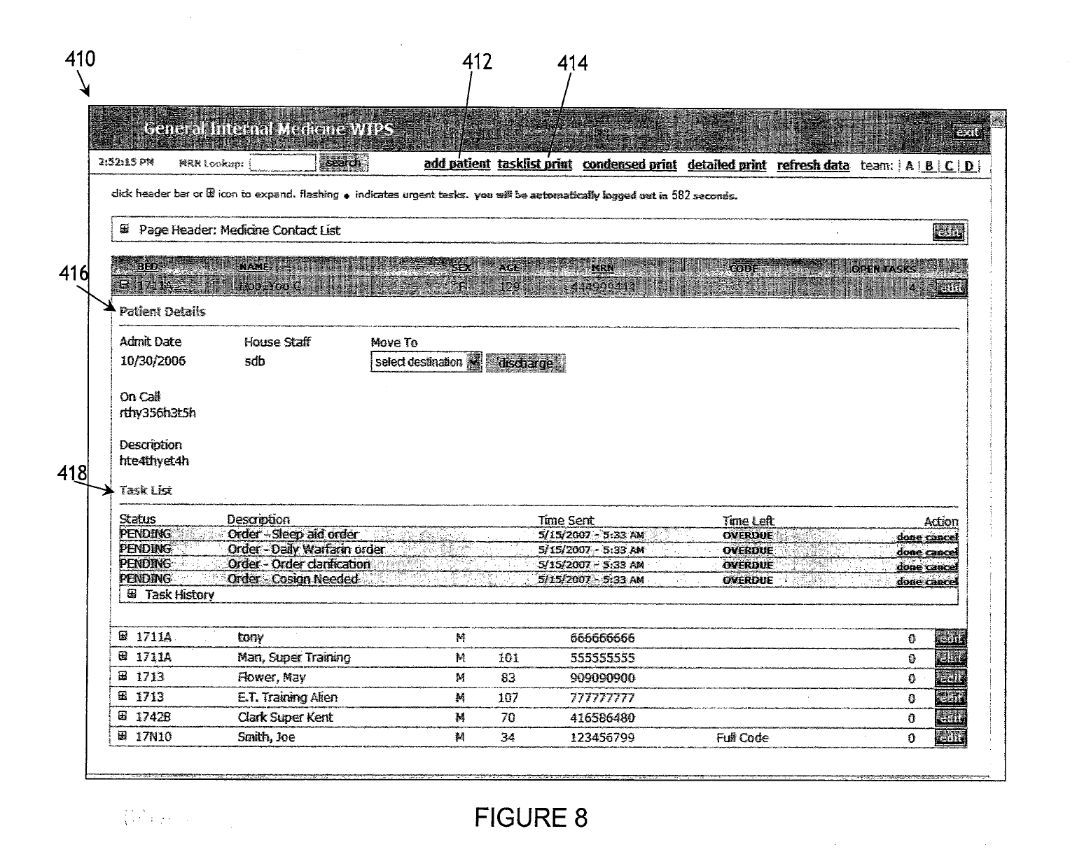

Reference is now made to FIG. 8, where a sample patient list window 410 is shown. The sample patient list window 410 preferably displays to the user the various patients that are associated with the user and the user's department. The patient list window 410 provides the health care professional with the functionality to add patient information through the add patient link 412. The add patient link 412 preferably allows the user to add a patient profile. The patient list window 410 also has a print tasklist link 414. The print link 414 displays and prints the tasklist associated with a particular patient. The patient details window 416 displays the personal and health-related information for a particular patient. The patient details window 416 provides information regarding each patient, including the physician information. The task list window 418 displays the task list that is associated with a particular patient. As is illustrated with reference to the creation of non-urgent messages, tasks that form part of the task list have associated with them a time they were created and an allotted time for their completion. One of the fields of the task list window is a time left field which indicates the duration of the time remaining for the task to be completed within the allotted time frame. Where the time for completion of the task has elapsed, the time left field will show that the time has expired. In the task list window 418, an action field is also present. The action field provides the user with the option of indicating that the task has been completed or that it is to be cancelled. The user may also specify that the task has been deferred, which indicates to other users that the physician 20 is aware of the task and has made a determination to defer its completion.

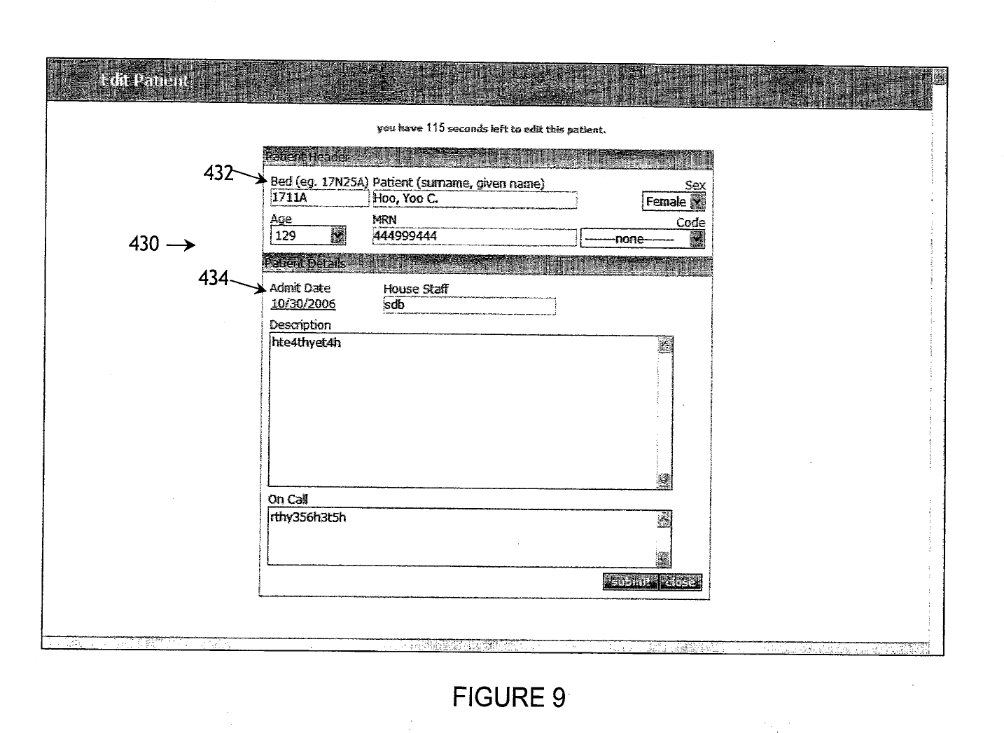

Reference is now made to FIG. 9, where a sample patient edit window 430 is shown. The patient edit window 430 allows the respective health care professional to edit information regarding a selected patient. The patient header window 432 allows information regarding the patient's name, location, age, sex, patient identifier and code status (signaling a resuscitation order) to be edited. The patient details window 434 allows the respective health care professional to enter information regarding the patient's condition and information regarding the physician on duty.

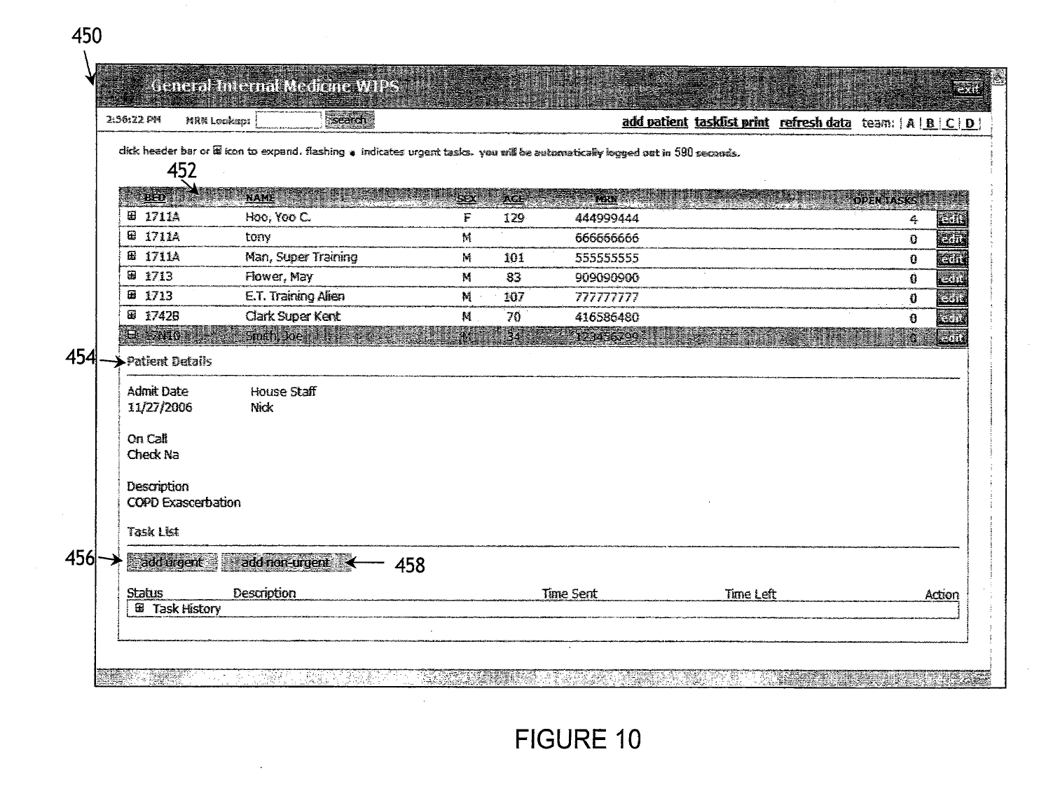

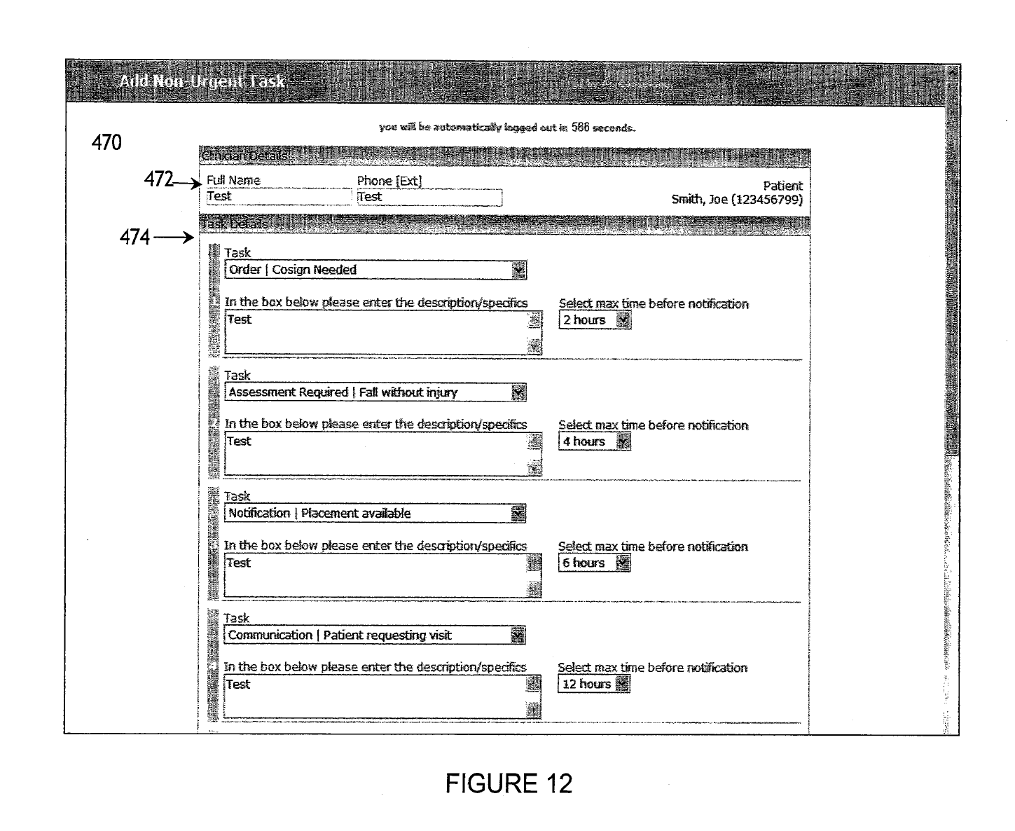

Reference is now made to FIG. 10 where a sample departmental list window 450 is shown. The sample departmental list window 450 displays the patients that are admitted for each respective ward or department. For each patient that is shown, the user may view the number of tasks that require completion, and may edit the task lists that are associated with each patient. When a patient's name is selected and clicked on, preferably the option of adding a non-urgent matter to the task list or for sending an urgent message is provided. The health care professional may select to send an urgent message by selecting the urgent task icon 456. When the urgent task icon 456 is selected, the urgent task window 460 as illustrated in FIG. 11 is shown. When the non urgent task icon 458 is selected, the non urgent task window as illustrated in FIG. 12 is shown.

Reference is now made to FIG. 11, where a sample screen shot of an urgent task window 460 is shown. The urgent task window 460 is used by the respective health professional 15 to communicate an urgent patient message to the physician 12. The urgent task window 460 in an exemplary embodiment has a physician window 462. In the physician window 462 the health care professional may enter the name and communication contact information for the health care professional. In one embodiment, messages will be generated and transmitted to the appropriate physician 12 as the system 10 is made aware regarding the physician 12 that is on duty. The system 10 is aware of the respective physician on duty who will be responsible for a patient through a sign-in system where the respective physicians who are on duty sign in. In alternative embodiments, contact details including contact information (such as a pager number, or a mobile phone number) may be entered for a specific respective physician 12 the health professional wishes to communicate a patient care message to. The physician window also lists the patient identifier, including the name and patient number associated with the selected patient.

The physician window 460 further comprises a task details window 464. The task details window 464 lists common medical ailments that may require urgent attention. The health care professional may select from among one or more of the listed medical ailments. Where the health care professional wishes to provide information in addition to the listed medical ailments, the user may enter the information in the informational field 466. Alternatively, where the listed medical scenarios do not fit the patient situation, but urgent care is required, a message describing the patient's condition may be entered in the informational field 466.

Reference is now made to FIG. 12, where a sample non-urgent task window 470 is shown. The non-urgent task window may be used by health care professionals to add a non urgent message to the task list. The non-urgent task window 470 has a health professional window 472, where the details of the health care professional who has submitted the task are specified. The non-urgent task window further comprises a task details window 474. In the task details window 474, the user is able to specify the tasks, along with a description and a time for completion.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of communicating a patient care message, the method comprising:
a) inputting patient information into the patient care message;
b) inputting an urgency indicator into the patient care message;
c) inputting health condition information into the patient care message;
d) transmitting the patient care message electronically, wherein the patient care message comprises the patient information, the urgency indicator, and the health condition information.

2. The method of claim 1, wherein the patient care message may be transmitted to a paging device.

3. The method of claim 1, wherein the patient care message may be transmitted to a mobile device.

4. The method of claim 1, wherein the interface is accessed online.

5. The method of claim 1, wherein the patient care message further comprises contact information for a requesting health professional.

6. The method of claim 1, wherein the patient care message is stored for subsequent retrieval through an online interface.

7. The method of claim 1, wherein one or more health care professionals may view all patient care messages that have been transmitted.

8. The method of claim 7, wherein the patient care messages may be viewed through an online interface.

9. The method of claim 1, wherein a physician receiving the patient care messages, may access an online interface and submit notes regarding the patient care message.
